(19) United States
(12) Patent Application Publication
(10) Pub. No.: US 2008/0247589 A1
(43) Pub. Date: Oct. 9, 2008

(54) Earplug Earphone

(75) Inventors: Chun-Hsin Liu, Taipei County (TW); Chung-Chun Wu, Taipei City (TW); Han-Sheng Chen, Taipei City (TW)

Correspondence Address: BEVER HOFFMAN & HARMS, LLP;2099 Gateway Place, Suite 320, San Jose, CA, 95110, US

(73) Assignee: Lite-On Technology Corp., Taipei (TW)

(21) Appl. No.: 11/874,165

(22) Filed: Oct. 17, 2007

(30) Foreign Application Priority Data
Apr. 3, 2007 (TW) 096205435

(51) Int. Cl. H04R 25/00

(52) U.S. Cl. 381/380

(57) ABSTRACT

An earplug earphone with a special engagement is provided. The earplug earphone includes a body and an earplug. The body has a protruding connecting portion, wherein the protruding connecting portion has a first engaging element on the inner side thereof. The earplug includes a protruding portion having a second engaging element. The earplug is fixed to the body by engagement of the engaging elements. After the protruding connecting portion is combined with the protruding portion, a buffering segment spaced apart in an appropriate distance is formed between the earplug and the body. The buffering segment has an advantage for the earplug to match different external auricles of different users and to be inserted in the ears of different users, thereby making the earplug earphone of the present invention further conform to ergonomics.

### FIELD OF THE INVENTION

The present invention relates to an earplug earphone, and more particularly to a firmly assembled bluetooth and ergonomic earplug earphone for transmitting/receiving radio signals.

### BACKGROUND OF THE INVENTION

The earphone is a common electric appliance for a user to listen to the sounds output from audio facilities or other multimedia facilities. As technology progresses rapidly, music players develop from the hi-fi equipments and CD players to the portable appliances such as MP3 players, and the requirements of earphones also increase although there have been lots of earphones on the market. Please refer to FIG. 1, which is an exploded diagram of a conventional earplug earphone, wherein the earplug earphone 1 includes a body 10, a lower cover 12, and an upper cover 13. The body 10 has a connecting hole 11, and the lower cover 12 has spiral threads 121. When the lower cover 12 enters the connecting hole 11, the spiral threads 121 spin into the corresponding spiral threads at the inside of the connecting hole 11, so that the lower cover 12 is combined with the body 10 thereby.

An earplug earphone is much smaller than a headphone, and the fixation thereof is achieved by inserting the earplug into external auricle of a user. Thus, the earplug earphone is suitable to be applied in a bluetooth earphone with additional batteries and wireless receiving/transmitting apparatus, or an earphone with a microphone. An earplug earphone includes a body and an earplug fixed to the body. The length of the body is about 4-5 cm, and the diameter of the earplug is about 1 cm. However, the spiral threads 121 and the corresponding spiral threads at the inside of the connecting hole 11 in FIG. 1 are even tinier structures, and they would be split or not suitable for different ear canals of different users if these tiny structures are designed inappropriately. Under this situation, the earplug is neither ergonomic nor comfortable for the user.

The conventional earplug earphone has the following drawbacks: 1) As shown in FIG. 1, the lower cover 12 is combined with the body 10 through the corresponding spiral threads 121 on the outer and the inner walls. Nevertheless, the spiral threads 121 have a complex surface, which leads to a higher cost when manufacturing a slide mold. 2) Please refer to FIG. 2, which is a cross sectional view along X-X′ line of the conventional earplug earphone in FIG. 1. The conventional earplug earphone includes a body 20, a lower cover 22, and an upper cover 23. Due to the influence of the spiral threads 121, the thickness of the earplug is decreased from a to b, and the strength of the combination point is also weakened accordingly. 3) Additionally, the lower cover 22 has a protruding length of c. After the lower cover 22 is combined with the body 20, the outside protruding length is decreased to d; in other words, the earplug is very close to the body. Therefore, the user will feel uncomfortable and the earplug is unfirm therewith when it is inserted into the user's external auricle. Under this situation, the earplug does not meet the requirement of ergonomics and may drop out from the user's external auricle.

In order to overcome the drawbacks in the prior art, an earplug earphone with a special engagement is provided. The present invention overcomes the drawbacks of the prior art described above, and the summary of the present invention is described as follows.

### SUMMARY OF THE INVENTION

It is a general object of the present invention to provide an earplug earphone with a special engagement. A more specific object of the present invention is to provide an earplug earphone with special engaging elements not only for enhancing the connecting strength between the body and the earplug, but also for providing a comfortable wear and a stationary effect. Moreover, another specific object of the present invention is to provide an earplug earphone with a lower molding cost and fabrication convenience.

In order to achieve the above objects, the present invention provides a novel earplug earphone. The earplug earphone includes a body, and an earplug. The body has a protruding connecting portion with a first engaging element on the inner side thereof. The earplug has a sound conveyed unit and a protruding portion, wherein the sound conveyed unit is placed into the external ear of a user, and the protruding portion has a second engaging element. When the protruding portion engages with the protruding connecting portion, the earplug is fixed to the body by an engagement of the engaging elements.

According to above stated objects, the engaging elements have corresponding structures for engaging with each other.

In one preferred embodiment, the protruding connecting portion has a plurality of protrusions on the inner side thereof, and the protruding portion has a plurality of recesses. Moreover, the cost of molding and manufacturing such corresponding engaging elements will not increase due to the easier mold manufacturing technology. Further, the connecting point of the earplug earphone remains the original thickness and strength.

In one preferred embodiment, the first engaging element is composed of three protrusions, and the second engaging element is composed of three recesses for engaging with the three protrusions.

In an exemplary embodiment, the engagement of the engaging elements provides a buffering segment between the earplug and the body after assembly through firmly engaging a protruding connecting hole on the body with a protruding tube on the earplug. The buffering segment spaces the earplug and the body in appropriate distance, and thus the earplug can match different external auricles of different users and can be inserted in the ears of different users. The buffering segment provides a stationary effect and a comfortable wear so as to further comply the earplug earphone of the present invention with ergonomics. By the above engagement, the earplug earphone resolves the drawback of dropping out easily from the user's external ear in the conventional earplug earphone.

In another preferred embodiment, the earplug earphone further includes a hanging device for hanging the earplug earphone on a user. The earphone can be carried easily by using a rope or a clip passing the hanging device. When the earphone is left unused, the hanging device further provides a collecting function for the earphone, such as being hanged on a wall.

In still another preferred embodiment, the earplug earphone further includes an ear hanger for hanging the earplug earphone on an external ear of a user.

It is another object of the present invention to provide an apparatus including a body and an earplug. In one preferred embodiment, the body has the first protruding portion with the first engaging element on the inner side thereof, and the earplug includes a sound conveyed unit and the second protruding portion. The sound conveyed unit is being placed into the external ear of a user, and the second protruding portion has the second engaging element. When the second protruding portion passes through the first protruding portion, the second engaging element engages with the first engaging element for fixing the body to the earplug. Accordingly, the engagement of the engaging elements provides a buffering segment between the earplug and the body for spacing the earplug and the body apart in appropriate distance.

According to the above stated object, the body further includes a radio transmitting/receiving apparatus.

In one preferred embodiment, the radio transmitting/receiving apparatus is a bluetooth earphone.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is an exploded diagram of a conventional earplug earphone;

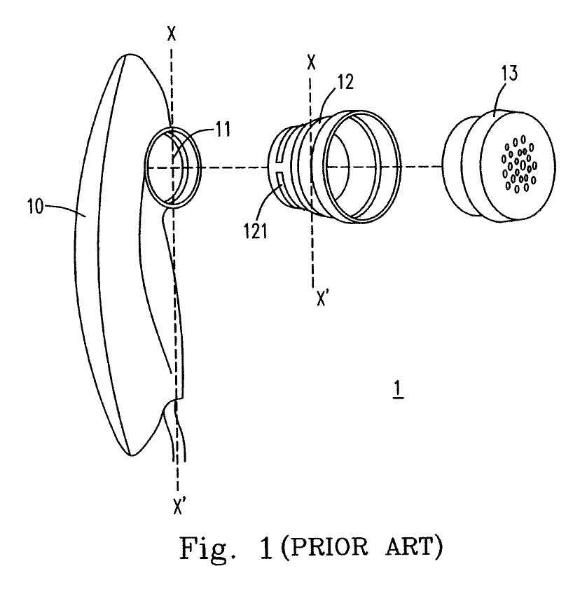

FIG. 2 is a cross sectional view along X-X′ line of the conventional earplug earphone in FIG. 1;

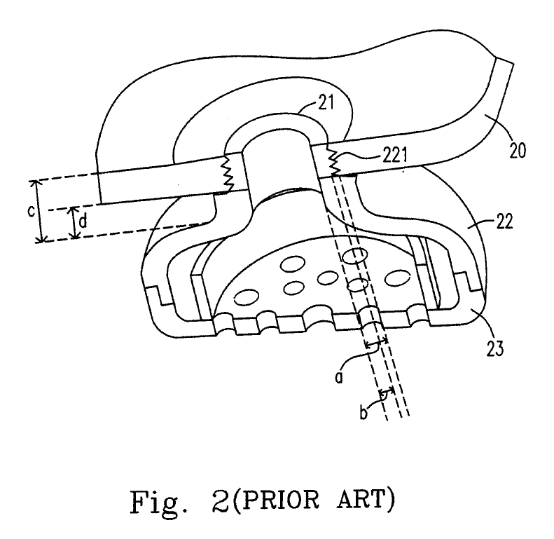

FIG. 3 is a diagram showing the earplug earphone according to the first preferred embodiment of the present invention after assembly;

FIG. 4 is an exploded diagram of the earplug earphone in FIG. 3;

FIG. 5 is a cross sectional view along Y-Y′ line of the earplug earphone in FIG. 4;

FIG. 6 is an exploded diagram of the earplug earphone in FIG. 5;

FIG. 7 is an exploded diagram of the earplug earphone according to the second preferred embodiment of the present invention;

FIG. 8 is an exploded diagram of the earplug earphone according to the third preferred embodiment of the present invention;

FIG. 9 is a diagram showing the earplug earphone according to the forth preferred embodiment of the present invention after assembly; and

FIG. 10 is a diagram showing the earplug earphone according to the fifth preferred embodiment of the present invention after assembly.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

### First Preferred Embodiment

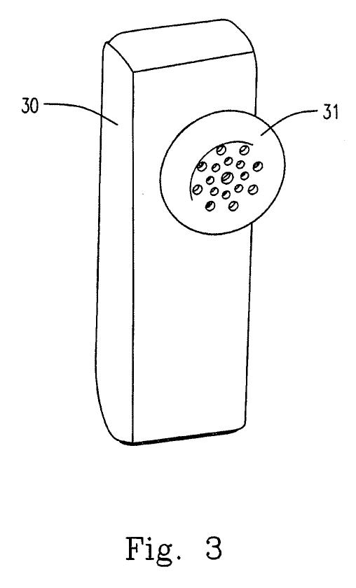

Please refer to FIG. 3, which is a diagram showing the earplug earphone according to the first preferred embodiment of the present invention after assembly. The earplug 31 is fixed to the body 30 after assembly, and a user can wear the earplug 31 firm when it is inserted into the external auricle of the user. The body 30 includes one of a radio transmitting/receiving apparatus for receiving an external audio signal, and an apparatus using wireless protocol, i.e. Bluetooth Protocol, for receiving the audio signal through an electronic apparatus.

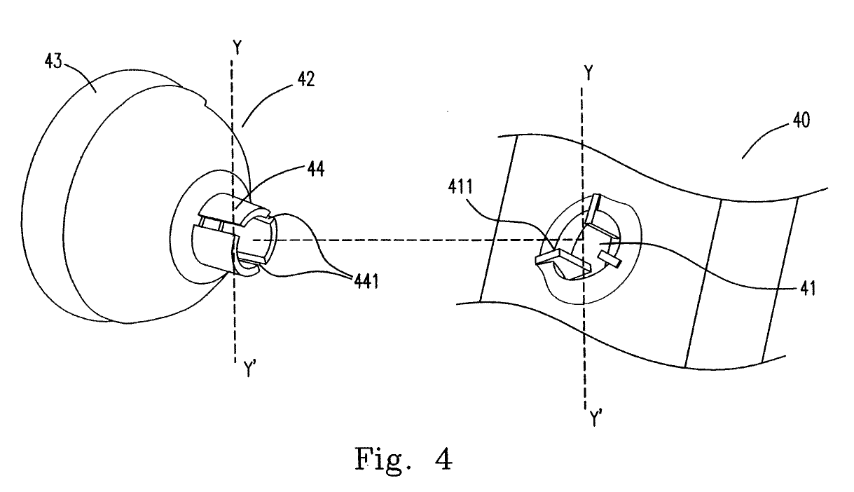

Please refer to FIG. 4, which is an exploded diagram of the earplug earphone in FIG. 3. Although the first preferred embodiment refers to a bluetooth earphone, the earplug earphone of the present invention can also be applied to other types of earphones. The earplug earphone in FIG. 4 includes a body 40 and an earplug 42, wherein the body 40 has a protruding connecting hole 41 with protrusions 411 on the inner side thereof. In the present embodiment, the protrusions 411 are three ribs with equal width, equal height and equal depth so that an engaging element with three claws is formed. The earplug 42 has a sound conveyed unit 43 and a protruding tube 44, wherein the sound conveyed unit 43 is used for being inserted into the external ear of a user, and the protruding tube 44 has recesses 441 with the same number corresponding to the protrusions 411. Based on the above description, the protruding tube 44 also has three recesses 441 corresponding to the three protrusions 411 on the protruding connecting hole 41. When the protruding tube 44 passes through the protruding connecting hole 41, the protrusions 411 evenly engage into the recesses 441 for fixing the earplug 42 to the body 40. After the protruding connecting hole 41 is combined with the protruding tube 44, a buffering segment c1 spaced apart in an appropriate distance, described in next paragraph, is formed between the earplug 42 and the body 40. The buffering segment has an advantage for the earplug 42 to match different external auricles of different users and to be inserted in the ears of different users, thereby the earplug earphone of the present invention further comply with ergonomics. In the present invention, the respective shapes of the protrusions 411 and the recesses 441 are corresponsive, but the recesses 441 are slightly smaller than the protrusions 411 so that the strength of the connecting point between the body 40 and the earplug 42 is increased. An earplug earphone fabricated by the above-mentioned engaging elements has many advantages; it can be fabricated easily, and the cost of mold would be lower, and furthermore, the earplug earphone provides a better fixation and comfortable effect for a user.

The sound conveyed unit 43 on the earplug 42 is used for being placed near to the external ear of a user. A voice conveyed element (not shown) is set inside the sound conveyed unit 43. When the body 40 receives an external audio signal, the voice conveyed element transforms the audio signal received by the body 40 to a voice through the sound conveyed unit 43. Furthermore, the earplug earphone of the present invention can serve as a microphone and an earphone at the same time if the body 40 has a voice receiving unit (not shown) for receiving voice of a user and converting it to an audio signal on the other end opposite to the protruding connecting hole 41. Alternatively, the voice receiving unit may be disposed outside the body 40.

Moreover, the present invention can also be applied to other audio apparatuses containing an earplug, for example, the body 40 may be other radio audio transmitting/receiving apparatuses besides the bluetooth earphone, such as a bluetooth MP3 player.

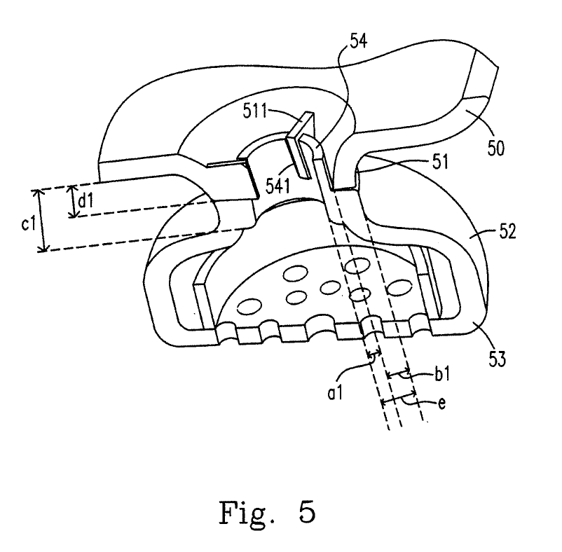

Please refer to FIG. 5, which is a cross sectional view along Y-Y′ line of the earplug earphone in FIG. 4. The earplug earphone in FIG. 5 includes a body 50 and an earplug 52, wherein the body 50 and the earplug 52 have the same structures as described in FIG. 4. In FIG. 5, the thickness of the protruding tube 54 is labeled as a1, and the thickness of the protruding connecting hole 51 is labeled as b1. When the body 50 is combined with the earplug 52, the thickness of the connecting point shall be e by adding up the thickness a1 of the protruding tube 54 and the thickness b1 of the protruding connecting hole 51, and thus the engaging strength would be increased. Besides, the length of the protruding tube 54 is c1, and the length of the protruding connecting hole 51 outward of the body 50 is d1. The distance between the body 50 and the earplug 52 is not too short and be maintained as c1 after assembly. When the earplug is inserted into the external ear of a user, a buffering segment with a length of c1 is formed, which enables the earplug to be fixed to the external ear easily and more comfortable.

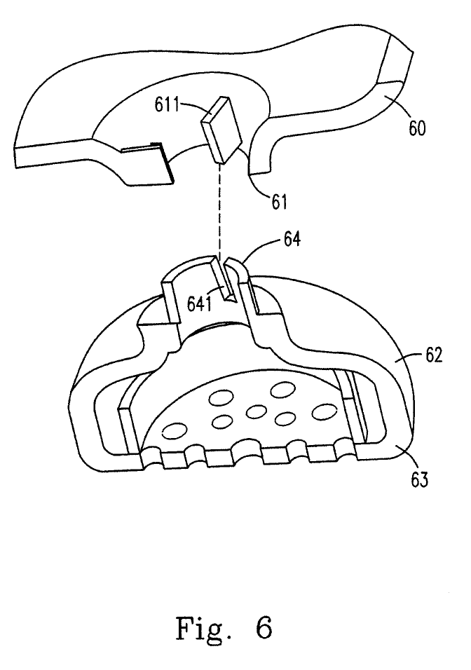

Please refer to FIG. 6, which is an exploded diagram of the earplug phone in FIG. 5 in which further detailed structure of the earplug earphone of the present invention is clearly illustrated. The body 60 has a protruding connecting hole 61 with protrusions 611 on the inner side thereof. The earplug 62 has a sound conveyed unit 63 and a protruding tube 64, the sound conveyed unit 63 can be inserted into the external ear of a user, and the protruding tube 64 has recesses 641 in corresponding shapes to the protrusions 611. The protrusions 611 and the recesses 641 are arranged as a radiate shape, so that the engaging elements can appropriately engage with each other after assembly as FIG. 5 shows.

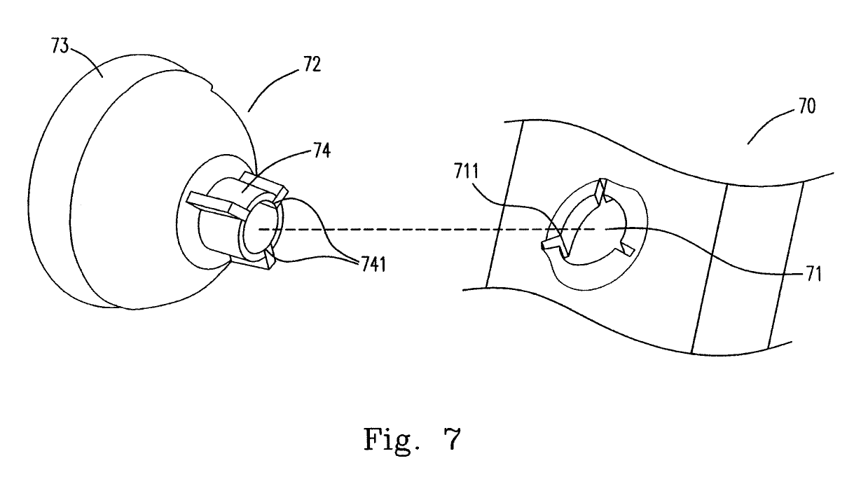

Please refer to FIG. 7, which is an exploded diagram showing the second preferred embodiment of the present invention. The difference between the second and the first preferred embodiments lies in that the positions of the protrusions and the recesses are exchanged. Accordingly, the protruding connecting hole 71 has three recesses 711 on the inner side thereof, and the protruding tube 74 has three protrusions 741 on the outer side thereof. In the earplug earphone with such engagement, the earplug 72 can also be fixed on the body 70 through engaging the protrusions 741 with the recesses 711 evenly and appropriately. After combination of the protruding connecting hole 71 and the protruding tube 74, the earplug earphone in this embodiment also has a buffering segment between the earplug 72 and the body 70, and remains the advantages of conforming to ergonomics and convenient assembly.

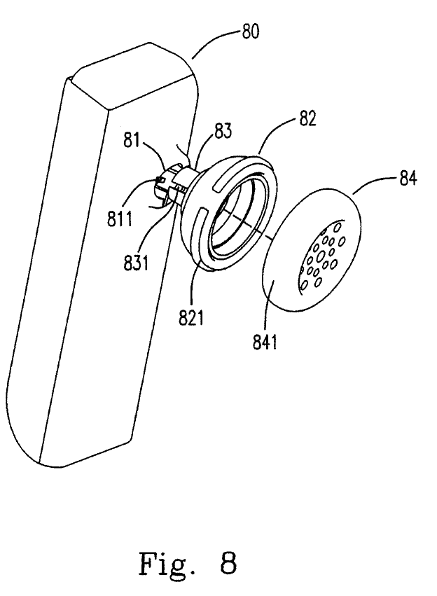

Please refer to FIG. 8, which is an exploded diagram of the earplug earphone according to the third preferred embodiment of the present invention. According to the third preferred embodiment, the engagement of the earplug earphone is generally the same as the first preferred embodiment except the earplug. The earplug herein includes an integrated housing containing a lower earplug cover 82 and an upper earplug cover 84. A sound conveyed unit could be configured in the upper earplug cover 84 with a corresponding structure to the sound conveyed unit. For example, some holes on the upper earplug cover 84 can be provided for transmitting voice, or a soft sheath enveloping the upper earplug cover 84 can be provided as a comfortable contact. When the protruding tube 83 passes through the protruding connecting hole 81, the protrusions 811 engage with the recesses 831 for fixing the lower earplug cover 82 to the body 80. Moreover, the upper earplug cover 84 has an extended unit extending toward the body 80, wherein the extended unit engages with a circular engaging element on the lower earplug cover 82 so that another type of bluetooth earphone is formed.

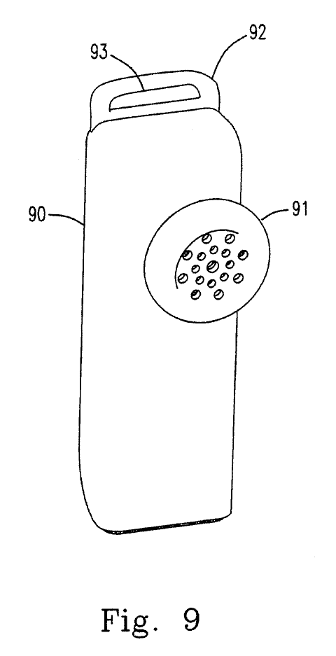

Please refer to FIG. 9, which is a diagram showing the earplug earphone according to the forth preferred embodiment of the present invention after assembly. As FIG. 9 shows, the earplug earphone includes a body 90, an earplug 91, and a hanging device 92 with a hole 93. The typical structure of the earplug earphone herein is the same as FIG. 3, but an additional hanging device is provided. The earphone can be carried easily by using a rope or a clip passing the hole 93. When the earphone is left unused, the hanging device provides a further collecting function for the earphone, such as being hanged on a wall.

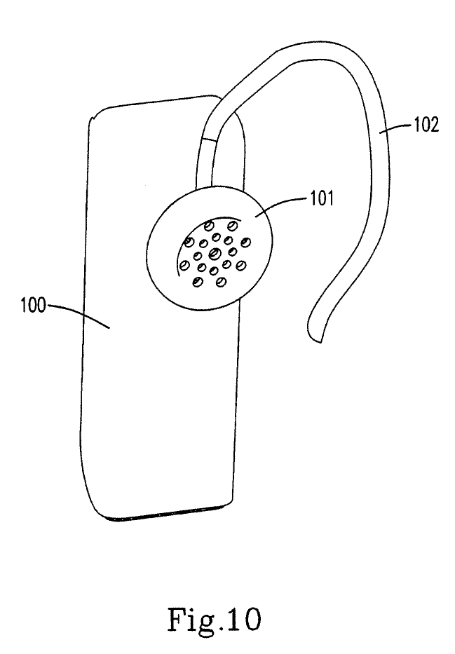

Please refer to FIG. 10, which is a diagram showing the earplug earphone according to the fifth preferred embodiment of the present invention after assembly. The basic structure of the earplug earphone is generally the same as the first preferred embodiment except the ear hanger 102. The ear hanger 102 is fixed on the body 100 for hanging the earplug earphone on the external ear of a user.

Based on the above embodiments, it is known that the earplug earphone of the present invention is composed of a special engagement with corresponding engaging elements. While the first engaging elements are protrusions, the second engaging elements are recesses (as FIG. 4 shows). Similarly, while the first engaging elements are recesses, the second engaging elements are protrusions (as FIG. 7 shows). After the protrusions engage with the recesses, the earplug is fixed on a body containing a wireless transmitting/receiving apparatus. Moreover, the cost of molding and manufacturing such an earplug earphone with the above engaging element will not increase due to the easier mold manufacturing technology. Further, the connecting point of the earplug earphone has the original thickness and strength.

The respective structures described in the embodiments of the present invention can exist alone, or be combined with each other according to actual needs. For example, the ear hanger and the hanging device of the earplug earphone may be designed variously for conforming to requirements of different users.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An earplug earphone comprising:
a body having a protruding connecting portion, wherein the protruding connecting portion has a first engaging element on an inner side thereof; and
an earplug including a protruding portion having a second engaging element, wherein the earplug is fixed to the body by an engagement of the engaging elements.

2. The earplug earphone as claimed in claim 1, wherein the engaging elements have corresponding structures for engaging with each other.

3. The earplug earphone as claimed in claim 2, wherein the first engaging element is a protrusion configured on the inner side, and the second engaging element is a recess configured on the protruding portion.

4. The earplug earphone as claimed in claim 3, wherein the first engaging element is composed of three protrusions, and the second engaging element is composed of three recesses for engaging with the three protrusions.

5. The earplug earphone as claimed in claim 1, wherein the engagement of the engaging elements provides a buffering segment between the earplug and the body for spacing the earplug and the body apart in an appropriate distance.

6. The earplug earphone as claimed in claim 1, wherein the earplug further comprises one of a monolithically formed housing and an integrated housing comprising an upper earplug cover and a lower earplug cover.

7. The earplug earphone as claimed in claim 1, wherein the earplug further comprises a sound conveyed unit to be placed into an external ear of a user.

8. The earplug earphone as claimed in claim 1, further comprising a hanging device for hanging the earplug earphone on a user.

9. The earplug earphone as claimed in claim 1, further comprising an ear hanger for hanging the earplug earphone on an external ear of a user.

10. A hearing apparatus comprising:
a body having a first protruding portion with a first engaging element on an inner side thereof; and
an earplug including a second protruding portion with a second engaging element engaging with the first engaging element for fixing the body to the earplug.

11. The apparatus as claimed in claim 10, wherein the body further comprises a radio transmitting/receiving apparatus.

12. The apparatus as claimed in claim 11, wherein the radio transmitting/receiving apparatus is a bluetooth earphone.

13. The apparatus as claimed in claim 10, wherein the engaging elements have corresponding structures for engaging with each other.

14. The apparatus as claimed in claim 13, wherein the first engaging element is a protrusion configured on the inner side, and the second engaging element is a recess configured on the protruding portion.

15. The apparatus as claimed in claim 14, wherein the first engaging element is composed of three protrusions, and the second engaging element is composed of three recesses for engaging with the three protrusions.

16. The apparatus as claimed in claim 10, wherein the engagement of the engaging elements provides a buffering segment between the earplug and the body for spacing the earplug and the body apart in an appropriate distance.

17. The apparatus as claimed in claim 10, wherein the earplug further comprises one of a monolithically formed housing and an integrated housing comprising an upper earplug cover and a lower earplug cover.

18. The apparatus as claimed in claim 10, wherein the earplug further comprises a sound conveyed unit to be placed into an external ear of a user.

19. The apparatus as claimed in claim 10, further comprising a hanging device for hanging the earplug earphone on a user.

20. The apparatus as claimed in claim 10, further comprising an ear hanger for hanging the earplug earphone on an external ear of a user.
